(19) United States
(12) Patent Application Publication
(10) Pub. No.: US 2023/0142231 A1
(43) Pub. Date: May 11, 2023

(54) TERMINAL AND COMMUNICATION METHOD

(71) Applicant: NTT DOCOMO, INC., Tokyo (JP)

(72) Inventors: Daiki Takeda, Chiyoda-ku, Tokyo (JP); Masashi Anzawa, Chiyoda-Ku, Tokyo (JP); Hiroki Ishizuka, Chiyoda-Ku, Tokyo (JP)

(73) Assignee: NTT DOCOMO, INC., Tokyo (JP)

(21) Appl. No.: 17/996,900

(22) PCT Filed: Apr. 23, 2021
(86) PCT No.: PCT/JP2021/016503

§ 371 Date: Oct. 21, 2022

(30) Foreign Application Priority Data
Apr. 27, 2020 (JP) 2020-078423

(51) Int. Cl. H04W 76/14

(52) U.S. Cl. CPC H04W 76/14

(57) ABSTRACT

A terminal includes: a reception unit configured to obtain information for starting a service that performs priority control related to communications, the service being applied to a group to which one or more terminals belong; and a control unit configured to start the service for the terminals that belong to the group, by using the information and by a trigger via direct communication between terminals or via a network.

### FIELD OF THE INVENTION

The present invention relates to a terminal and a communication method in a wireless communication system.

### BACKGROUND OF THE INVENTION

In 3GPP (3rd Generation Partnership Project), in order to achieve further larger system capacity, further faster data transmission speed, further lower latency in a wireless communication section, etc., a wireless communication method called 5G or NR (New Radio) has been discussed (hereinafter, the wireless communication method is referred to as “5G” or “NR”). In 5G, various wireless technologies have been discussed in order to meet requirements including latency equal to or less than 1 ms in a wireless section while achieving a throughput equal to or greater than 10 Gbps.

In NR, an architecture has been discussed which includes: 5GC (5G Core Network) corresponding to EPC (Evolved Packet Core) that is a core network in an LTE (Long Term Evolution) network architecture; and NG-RAN (Next Generation-Radio Access Network) corresponding to E-UTRAN (Evolved Universal Terrestrial Radio Access Network) that is a RAN (Radio Access Network) in the LTE network architecture (e.g., non-patent document 1).

In addition, in LTE and NR, a D2D (Device to Device) technique has been discussed in which terminals directly communicate with each other without involving a base station (e.g., non-patent document 2).

The D2D reduces traffic between the terminals and the base stations and enables communication between the terminals even when the base stations are unable to communicate during a disaster, etc. Note that, although D2D is referred to as “sidelink” in 3GPP, the more generic term D2D is used herein. However, in the description of embodiments described below, the sidelink is also used as needed.

The D2D communication is broadly classified into: D2D discovery for discovering other terminals capable of communication; and D2D communication (D2D direct communication, direct communication between terminals, etc.,) for direct communication between terminals. Hereinafter, when D2D communication and D2D discovery are not specifically distinguished, it is simply called D2D. A signal sent and received by D2D is called a D2D signal. Various use cases of V2X (Vehicle to Everything) services in NR have been discussed (e.g., Non-Patent Document 3).

### CITATION LIST

### Non-Patent Document

[Non-Patent Document 1] 3GPP TS 23.501 V16.3.0 (2019-12)
[Non-Patent Document 2] 3GPP TS 38.211 V16.0.0 (2019-12)
[Non-Patent Document 3] 3GPP TR 22.886 V15.1.0 (2017-03)

### SUMMARY OF THE INVENTION

### Technical Problem

In a case where NaaS (Network as a Service) targeting the D2D communication is used, depending on the assumed scenario such as a fighting game, it becomes necessary for NaaS to be configured not only to the terminal itself but also: to a terminal that is a communication target; or to a group including a plurality of terminals. However, according to the conventional technique, it is difficult for a terminal to have an initiative to trigger NaaS for another terminal or for a terminal group.

The present invention has been made in view of the above point, and an object is to start communications in which QoS (Quality of Service) is provided in a group to which the terminal belong, by a trigger via the direct communication between terminals or by a trigger via a network.

### Solution to Problem

According to the disclosed technique, a terminal is provided. The terminal includes: a reception unit configured to obtain information for starting a service that performs priority control related to communications, the service being applied to a group to which one or more terminals belong; and a control unit configured to start the service for the terminals that belong to the group, by using the information and by a trigger via direct communication between terminals or via a network.

### Advantageous Effects of Invention

According to the disclosed technology, communication in which QoS (Quality of Service) is provided in a group to which a terminal belongs can be started by a trigger via direct communication between terminals or via a network.

### BRIEF DESCRIPTION OF THE DRAWINGS

FIG. 1 is a drawing illustrating a wireless network according to an embodiment of the present invention.

FIG. 2 is a drawing illustrating a core network in an embodiment of the present invention.

FIG. 3 is a drawing illustrating an example of priority control according to an embodiment of the present invention.

FIG. 4 is a drawing illustrating an example (1) of communication in which NaaS is configured according to an embodiment of the present invention.

FIG. 5 is a flowchart illustrating an example (1) of communication in which NaaS is configured according to an embodiment of the present invention.

FIG. 6 is a drawing illustrating an example (2) of communication in which NaaS is configured according to an embodiment of the present invention.

FIG. 7 is a sequence diagram illustrating an example (2) of communication in which NaaS is configured according to an embodiment of the present invention.

FIG. 8 is drawing illustrating an example of a functional structure of a network node 10 according to an embodiment of the present invention.

FIG. 9 is drawing illustrating an example of a functional structure of a terminal 20 according to an embodiment of the present invention.

FIG. 10 is a drawing illustrating an example of a hardware structure of the network node 10 or the terminal 20 according to an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, conventional techniques will be used appropriately. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR), or wireless LAN (Local Area Network).

Further, in an embodiment of the present invention, the expression, radio parameters are “configured” may mean that a predetermined value is pre-configured, or may mean that a radio parameter indicated by a network node 10 or a terminal 20 is configured.

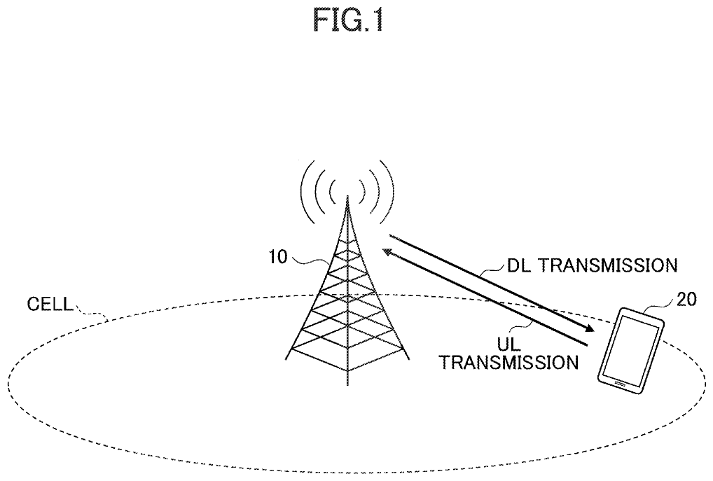

FIG. 1 is a drawing illustrating a wireless network according to an embodiment of the present invention. As illustrated in FIG. 1, a system including the wireless network according to an embodiment of the present invention includes a base station 10 and a terminal 20. In FIG. 1, a single base station 10 and a single terminal 20 are illustrated as an example. There may be a plurality of base stations 10 and a plurality of terminals 20. The base station 10 may be referred to as a network node 10.

The base station 10 is a communication apparatus that provides one or more cells and performs wireless communications with the terminal 20. Physical resources of the radio signal may be defined in the time domain and the frequency domain, the time domain may be defined by the number of OFDM symbols, and the frequency domain may be defined by the number of sub-carriers or resource blocks. The base station 10 transmits a synchronization signal and system information to the terminal 20. The synchronization signal is, for example, NR-PSS (Primary Synchronization Signal) and NR-SSS (Secondary Synchronization Signal). The system information is transmitted via, for example, NR-PBCH (Physical Broadcast Channel), and may be referred to as broadcast information. As shown in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, both the base station 10 and terminal 20 may perform communications via an SCell (Secondary Cell) and a PCell (Primary Cell) using CA (Carrier Aggregation).

The terminal 20 may be a communication apparatus that includes a wireless communication function such as a smart-phone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. In addition, the terminal 20 may have a function as a client application that communicates with an application server arranged in a network.

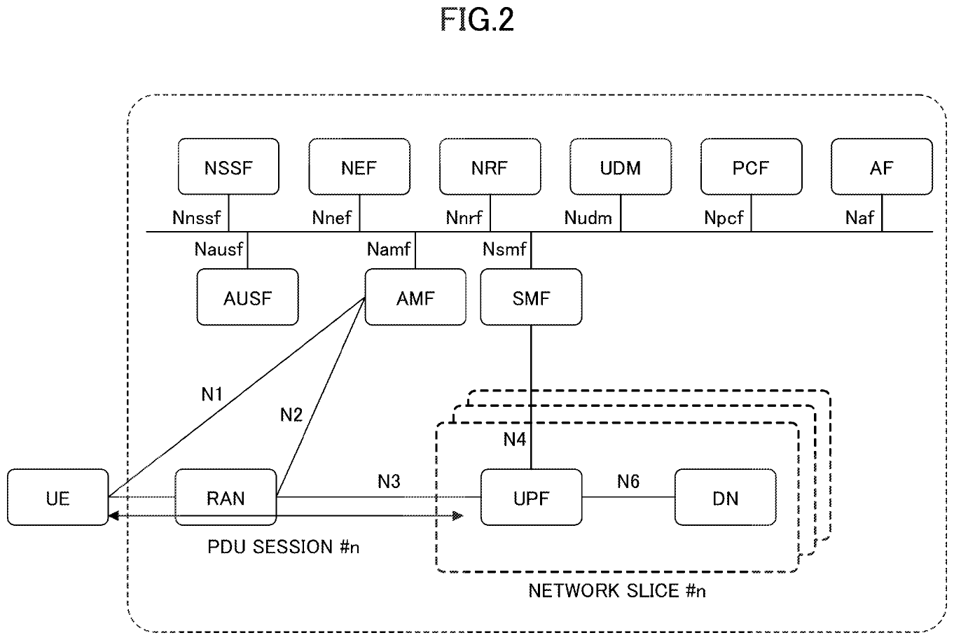

FIG. 2 is a drawing illustrating a core network in an embodiment of the present invention. As illustrated in FIG. 2, a system including a core network in an embodiment of the present invention consists of a UE, which is a terminal 20, and a plurality of network nodes 10. Hereafter, one network node 10 corresponds to each function, but multiple functions may be implemented by one network node 10 or one function may be implemented by multiple network nodes 10. The “connections” described below may be either a logical connection or a physical connection.

RAN (Radio Access Network) is a network node 10 with wireless access functions, and is connected to UE, AMF (Access and Mobility Management Function) and UPF (User plane function). The base station 10 may be a network node 10 corresponding to the RAN. The AMF is a network node 10 having functions of, for example, terminating the RAN interface, terminating the NAS (Non-Access Stratum), managing registration, managing connection, managing reachability, and managing mobility. The UPF is a network node 10 interconnected with DN (Data Network), and has functions such as a PDU (Protocol Data Unit) session point to an external unit, routing and forwarding packets, and QoS (Quality of Service) handling of the user plane. The UPF and the DN constitute a network slice. In a wireless communication network in an embodiment of the present invention, multiple network slices are included.

AMF is connected to UE, RAN, SMF (Session Management Function), NSSF (Network Slice Selection Function), NEF (Network Exposure Function), NRF (Network Repository Function), UDM (Unified Data Management), AUSF (Authentication Server Function), PCF (Policy Control Function), and AF (Application Function). AMF, SMF, NSSF, NEF, NRF, AUSF, PCF, and AF are network nodes 10 connected to each other via interfaces Namf, Nsmf, Nnssf, Nnef, Nnrf, Nudm, Nausf, Npcf, Naf based on the respective services.

The SMF is a network node 10 having functions such as session management, Internet Protocol (IP) address assignment and management of UE, DHCP (Dynamic Host Configuration Protocol) function, ARP (Address Resolution Protocol) proxy, and roaming function. The NEF is a network node 10 having a function of indicating capabilities and events to other NFs (Network Functions). The NSSF is a network node 10 having functions of, for example, selecting the network slice to which the UE is to be connected, determining the allowed NSSAI (Network Slice Selection Assistance Information), determining the configured NSSAI, and determining the AMF set to which the UE is to be connected. The PCF is a network node 10 having a function of performing policy control of the network. The AF is a network node 10 having a function of controlling an application server. The NRF is a network node 10 having a function of discovering NF instances which provide services.

Here, a service that provides a network called NaaS (Network as a Service) includes the concepts of 1)-4) below.

1) Network construction mainly for hardware deployment. A LAN (Local Area Network) including a network device such as a backbone router. For example, outsourcing of construction of a LAN in an office.
2) WAN (Wide Area Network) construction. A WAN including a virtualization technology such as a VPN. For example, a WAN construction enabling mutual access between branch offices and business offices.
3) Line services based on a specific network configuration or quality. Provision of IoT platforms. For example, IoT network installation by LoRAWAN (registered trademark) or the like, and an IoT solution for a corporation. In addition, for example, the service may be a service for providing a bandwidth-guaranteed line service to general users, and may include construction work.
4) A service that provides 3) above to general users on demand. A service in which users select network quality from multiple options to provide a line with quality such as “X Mbps bandwidth guaranteed” and “within Y msec latency”.

Embodiments of the present invention relate to a technology for implementing the NaaS of 4) above in a wireless network. In NaaS in a wired network, in addition to a peak rate and a failure rate, items such as a form of bandwidth guarantee classified into QoS and a delay time are defined as SLA (Service Level Agreement).

Examples of quality items that can be provided by the SLA are, for example, the following items 1) to 9). In a line service with SLA, SLA is defined in advance, and actions to be taken in the event of a violation are clarified. For example, in a case where the average delay time exceeds Y msec, an agreement is made such that the fee is reduced by Z %.

1) Traffic related items (average throughput, delay time, packet loss rate, etc.)
2) Utilization rate/Availability
3) Failure indication
4) Number of simultaneous connections
5) Backup-related items (Frequency, items, storage period, etc.)
6) Log related items (Frequency, items, storage period, etc.)
7) Support desk and other contact systems
8) Failure related items (recovery time, response time, on-site response availability, etc.)
9) Types of quality levels listed above

No technology presently supports QoS guarantees for Layer 1-Layer 2 or other wireless link sections. On the other hand, there are functions that are optimized for the requirement of constantly sending small packets, such as voice calls. Table 1 shows examples of functions similar to QoS as EPC (Evolved Packet Core) functions assuming a voice call or the like in LTE.

TABLE 1

| | | | Delay | Loss | |
|---|---|---|---|---|---|
| QCI | Guarantee | Priority | Budget | rate | Application |
| 1 | GBR | 2 | 100 ms | 1e−2 | VoIP |
| 2 | GBR | 4 | 150 ms | 1e−3 | Video call |
| 3 | GBR | 5 | 300 ms | 1e−6 | Streaming |
| 4 | GBR | 3 | 50 ms | 1e−3 | Real time |
| | | | | | game |
| 5 | Non-GBR | 1 | 100 ms | 1e−6 | IMS |
| | | | | | signaling |
| 6 | Non-GBR | 7 | 100 ms | 1e−3 | Interactive |
| | | | | | game |
| 7 | Non-GBR | 6 | 300 ms | 1e−6 | TCP |
| 8 | Non-GBR | 8 | 300 ms | 1e−6 | protocol |
| 9 | Non-GBR | 9 | 300 ms | 1e−6 | (browsing, |
| | | | | | email, file |
| | | | | | download) |

As illustrated in Table 1, a QCI (QoS Class Identifier) is associated with guarantee or non-guarantee of bit rates (Guarantee), priority, allowable delay (Delay Budget), packet loss rate (Loss rate), and applications. For example, if the QCI is 4, the bit rate is guaranteed (GBR: Guaranteed bit rate), the priority is 3, the allowable delay is 50 ms, the packet loss rate is ten to the minus three (10-3), and the application is a real-time game. The base station 10 performs scheduling or the like in accordance with the QCI, and communication is performed so as to satisfy the parameters shown in Table 1. However, QoS is not guaranteed in actual communication.

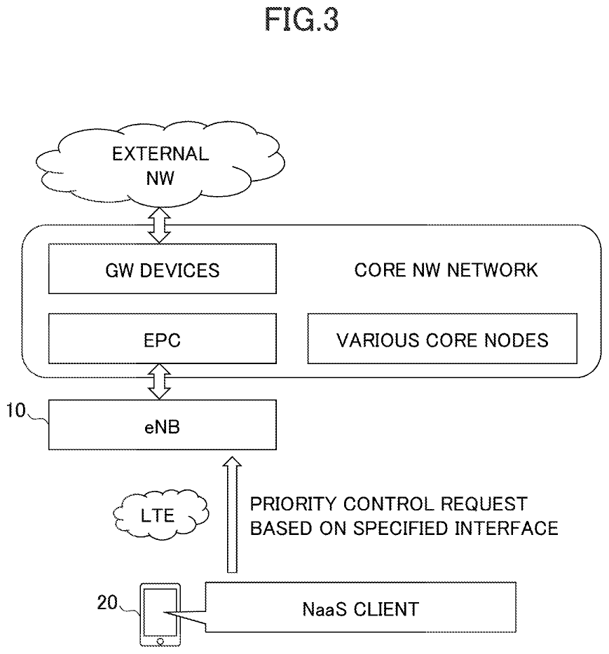

FIG. 3 is a drawing illustrating an example of priority control according to an embodiment of the present invention. Embodiments of the present invention contemplate NaaS that provides on-demand network quality to be selected by the user from a plurality of options. For example, network quality may be controlled as shown in FIG. 3. As shown in FIG. 3, the core network includes an EPC, various core nodes, GW devices, etc., and has communication channels with external networks and eNBs. It should be noted that in the embodiment of the present invention, priority control may be performed by any method, and the specific method of priority control is not limited.

For example, the terminal 20, as a NaaS client, may transmit a priority control request based on a specified interface to the base station 10 which is eNB via the LTE wireless network. As an example of priority and quality control implemented primarily by the base station 10, the desired network quality may be achieved by control via scheduling by the base station 10 and by changes of parameters by the base station 10. Also, as another example of priority and quality control implemented primarily by the core network, a MEC (Mobile Edge Computing) server may be located in the core network, or slicing control by the 5G core may be performed. Further, as an example of priority and quality control implemented primarily by the core network, the priority control function provided by the QCI control provided by the LTE may be implemented, or the control of the communication channel including the network and the terminal using the multiple PDNs or the like may be performed.

In the case of using NaaS for D2D communication, it is necessary to configure the NaaS not only for one's own terminal but also for the other terminal or a group of multiple terminals serving as communication partners, depending on the assumed scenario such as multi-point streaming distribution or a game.

As an example of the assumed scenario, when a 4K videophone or the like at two locations is assumed as an operation scenario of NaaS, the quality of each of the two locations needs to reach a required level. In this case, the caller of the video phone may trigger the NaaS of the other party.

As another example of the assumed scenario, it may be assumed that communication quality at multiple locations is balanced. For example, in a case where there are: a location A where low-latency communication is provided because the reception quality is sufficient or the physical distance to the application server is short; and a location B where the delay is large because the reception quality is insufficient or the physical distance to the application server is long, the requirements for the communication quality provision of the terminal 20 located at location A may be relaxed and resources may be preferentially allocated to the terminal 20 located at location B.

On the other hand, the priority control mechanism between the UE and the network in the current mobile network does not assume priority control between the specific UE group and the network under the above scenario. The specific UE group may be, for example, a set of user-specified UEs that may be referred to as a NaaS group.

For example, in a case where the information specifying the NaaS group is determined by a predetermined method such as a method in which the terminal 20 negotiates in advance in the application layer or a method in which the user orally acquires the UE identifier, a method of instructing the start of the NaaS is unclear. In addition, it may be also assumed that the terminals 20 belonging to the NaaS group do not support the D2D communication.

Thus, a single NaaS client may instruct multiple NaaS users to start NaaS. In an embodiment of the present invention, a method for triggering NaaS in D2D communication is proposed. As a premise of the proposal, it may be assumed that priority control different from that of NaaS in communication with the base stations 10 is provided in NaaS in D2D communication. For example, scheduling may be performed assuming that the same service is operated within the NaaS group and that the same degree of traffic is generated. In addition, for example, the network may determine to reduce the delay by applying the MEC only to NaaS in D2D communication. In order to implement the NaaS in the D2D communication, different network interfaces or indication methods may be defined between: the NaaS in the communication with the base stations 10; and the NaaS in the D2D communication. Note that, according to an embodiment of the present invention, the communication method of providing NaaS is not limited to D2D communication, and other communication methods may provide NaaS, such as, for example, terminal-to-base station communication. That is, in an embodiment of the present invention, “D2D communication” may be replaced by another communication method.

Note that “UE information to be configured as a NaaS group” described below is a set of information for identifying individual UEs, and may be, for example, a UE-ID on the RAN, an ID allocated in the service, an IP address, or the like.

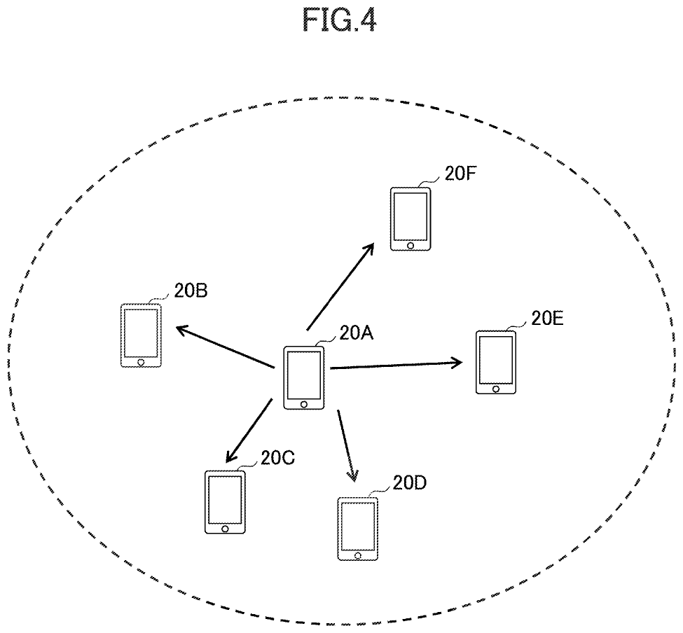

FIG. 4 is a drawing illustrating an example (1) of communication in which NaaS is configured according to an embodiment of the present invention. Terminal 20 may collect and determine the UE information to be configured as a NaaS group in a predetermined manner and may instruct each UE to initiate a NaaS request. The dashed line indicates a range of terminals 20 belonging to the NaaS group. As shown in FIG. 4, after collecting and determining the UE information to be configured as the NaaS group in the predetermined manner, terminal 20 A may send instructions to a terminal 20 B, a terminal 20 C, a terminal 20 D, a terminal 20 E and a terminal 20 F to initiate a NaaS request. Note that the terminal 20 A itself may also initiate the NaaS request.

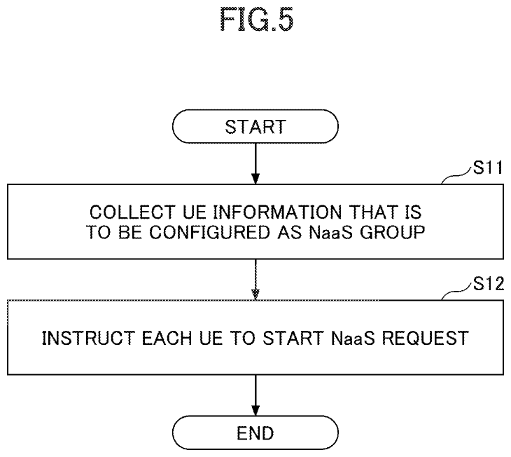

FIG. 5 is a flowchart illustrating an example (1) of communication in which NaaS is configured according to an embodiment of the present invention. In step S11, the terminal 20 A collects the UE information to be configured as the NaaS group by a predetermined method. Subsequently, the terminal 20 A instructs each UE included in the NaaS group to initiate the NaaS request (S12).

The operation of the terminal 20A in steps S11 and S12 may be an operation of an application, an operation of an operating system, or an operation of other standardized wireless communication functions.

In step S12, the terminal 20A may transmit the UE information to be configured as the NaaS group to each UE. Note that the UE information to be configured as the NaaS group may be, for example, a UE-ID in the RAN, an ID allocated in the service, an IP address, or the like. In addition, in step S12, the UE 20A may indicate, to each UE, time at which NaaS is started or ended and a period in which NaaS is applied.

In addition, in step S12, the terminal 20 A may indicate, to each UE, various parameters related to priority control. The various parameters may be, for example, a QCI, a peak rate, or a value for configuring requirements delay or reliability. The priority control may be considered to be guaranteed when all UEs within the group meet the requirements, or the priority control may be considered to be guaranteed when one UE within the group meets the requirements. It may be possible to distinguish between the priority control in which all UEs within the group meet the requirements and the priority control in which one UE within the group meets the requirements. For example, in a case where delay characteristics (average value, minimum value, jitter), data rates (uplink/downlink, average value, minimum value, peak value), reliability (average value, minimum value), and the number of simultaneous connections are configured as requirements, the requirements related to the average value may be configured not only as a time average but also as an average value of the entire UEs, or the requirements related to the maximum value may be configured as a maximum value of the entire UEs.

In addition, in step S12, the terminal 20 A may indicate, to each UE, information related to the failure indication. The information related to the failure indication may be, for example, an indication indicating that a failure has occurred in a UE in the group or that the configured requirements have become unable to be satisfied.

In obtaining the information to be indicated to each UE in step S12, the UEs in the NaaS group may communicate and negotiate with each other to determine the information to be indicated to each UE.

Note that the terminal 20A may transmit an indication to end the NaaS to any UE in the group at any timing.

The method for configuring the NaaS illustrated in FIGS. 4 and 5 is hereinafter referred to as Method A. When Method A is implemented by an application or an operating system, the D2D NaaS can be implemented even when the D2D NaaS is not defined in the standardized wireless communication function.

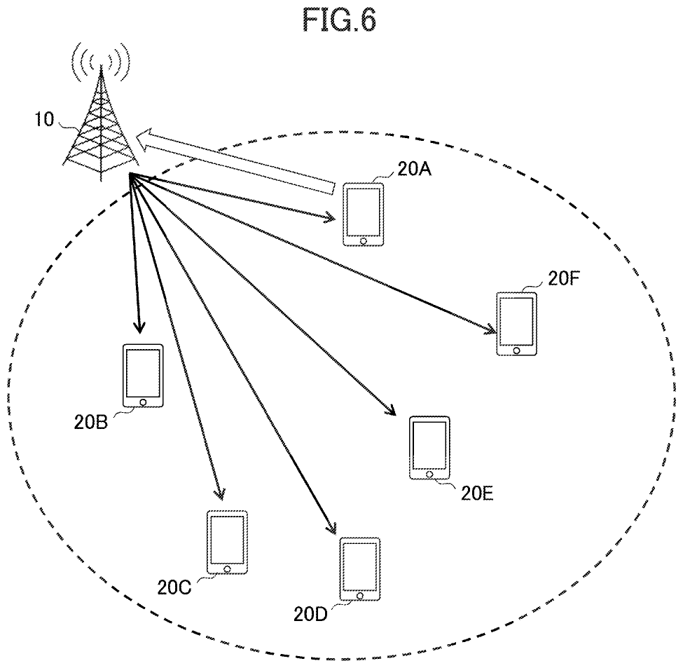

FIG. 6 is a drawing illustrating an example (2) of communication in which NaaS is configured according to an embodiment of the present invention. The terminal 20 may collect and determine the UE information to be configured as the NaaS group in a predetermined manner, may indicate, to the network, the UE information to be configured as the NaaS group, and the network may trigger the NaaS of the plurality of UEs. The dashed line indicates a range of terminals 20 belonging to the NaaS group. As illustrated in FIG. 6, the UE 20A collects and determines UE information to be configured as a NaaS group by a predetermined method, and then transmits the UE information to the BS 10. The base station 10 may transmit an instruction to start the NaaS request to the terminal 20B, the terminal 20C, the terminal 20D, the terminal 20E, and the terminal 20F. Note that the terminal 20A itself may also receive an instruction to start the NaaS request from the base station 10.

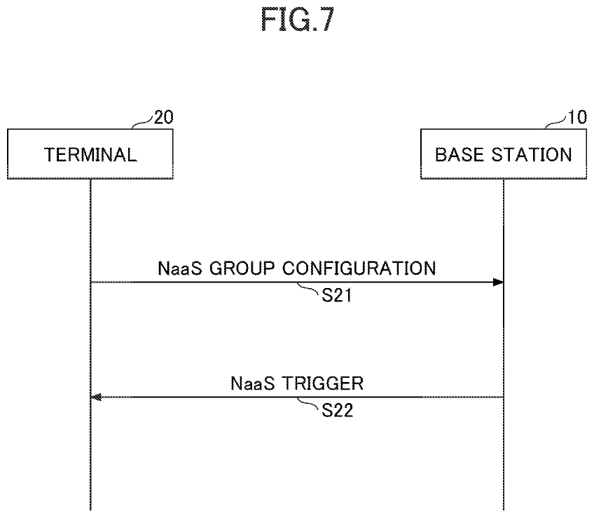

FIG. 7 is a sequence diagram illustrating an example (2) of communication in which NaaS is configured according to an embodiment of the present invention. In step S21, the terminal 20A collects the UE information to be configured as the NaaS group in the predetermined manner and then transmits the configuration of the NaaS group to the base station 10. Subsequently, the base station 10 instructs each UE included in the NaaS group to start the NaaS request as a NaaS trigger (S22).

The operations of the terminal 20A and the base station 10 in step S21 and step S22 may be operations of an application, operations of an operating system, or operations of any other standardized wireless communication function.

In step S21, the terminal 20A may transmit the UE information to be configured as the NaaS group to the base station 10. Note that the UE information to be configured as the NaaS group may be, for example, a UE-ID in the RAN, an ID allocated in the service, an IP address, or the like. In addition, in step S21, the terminal 20A may indicate, to the base station 10, time at which NaaS is started or ended and a period in which NaaS is applied.

In addition, in step S21, the terminal 20A may indicate, to the base station 10, various parameters related to priority control. The various parameters may be, for example, a QCI, a peak rate, or a value for configuring requirements delay or reliability. The priority control may be considered to be guaranteed when all UEs within the group meet the requirements, or the priority control may be considered to be guaranteed when one UE within the group meets the requirements. It may be possible to distinguish between the priority control in which all UEs within the group meet the requirements and the priority control in which one UE within the group meets the requirements. For example, in a case where delay characteristics (average value, minimum value, jitter), data rates (uplink/downlink, average value, minimum value, peak value), reliability (average value, minimum value), and the number of simultaneous connections are configured as requirements, the requirements related to the average value may be configured not only as a time average but also as an average value of the entire UEs, or the requirements related to the maximum value may be configured as a maximum value of the entire UEs.

In addition, in step S21, the terminal 20A may indicate, to the base station 10, information related to the failure indication. The information related to the failure indication may be, for example, an indication indicating that a failure has occurred in a UE in the group or that the configured requirements have become unable to be satisfied.

In addition, in step S21, the terminal 20A may indicate, to the base station 10, a condition related to a NaaS trigger. For example, a condition regarding geographic information may be indicated. The condition regarding geographical information may be information indicating a specific geographical range, or may be information indicating to belong to a specific base station, cell, or the like. Further, for example, a condition regarding the service may be indicated. The condition regarding the service may be a type of the service, may be an IP address and a port used for transmission and reception, or may be a condition regarding communication for a specific service. The information related to the failure indication may be information indicating that the condition regarding the geographical information or the condition regarding the service is not satisfied.

In obtaining the information to be indicated to the base station in step S21, the UEs in the NaaS group may communicate and negotiate with each other to determine the information to be indicated to the base station 10.

Note that the terminal 20A may transmit an indication to end the NaaS to the base station 10 at any timing.

The method for configuring the NaaS illustrated in FIGS. 6 and 7 is hereinafter referred to as Method B. In Method B, D2D NaaS without involving communication between terminals 20 can be implemented. In a case where an operation of a network is used, the operation being not based on the capability of the terminal 20, the NaaS can be applied even if the terminal 20 is not equipped with a NaaS client or the like.

Here, the terminal 20A illustrated in FIG. 4 or FIG. 6 may switch the method of instructing the start of the NaaS to Method A or Method B, based on the capability related to the priority control of the terminals 20 belonging to the NaaS group. For example, in a case where a certain terminal 20 belonging to the NaaS group does not have the capability of requesting the NaaS, the terminal 20 having the capability of requesting the NaaS may collectively request the priority to be applied to the terminals 20 belonging to the NaaS group.

In addition, the terminal 20A illustrated in FIG. 4 or FIG. 6 may switch the NaaS start instruction method to the above Method A or the above Method B according to the priority control capability of the network. For example, the Method A or the Method B may be selected for each function that provides NaaS, assuming that priority control is performed for each function. For example, in order to provide a more flexible NaaS triggering method, among the priority controls provided by the network, Method A may be selected for the priority control by slicing according to 5GC, and Method B may be selected for the priority control by other methods.

According to the above-described embodiment, the terminal 20 can trigger the start of NaaS from the terminal 20 itself for a plurality of UEs belonging to the NaaS group. In addition, the terminal 20 can cause the base station 10 to trigger the start of NaaS for the multiple UEs belonging to the NaaS group.

That is, communication in which QoS (Quality of Service) is provided in a group to which a terminal belongs can be started by a trigger: via direct communication between terminals; or via a network.

(Apparatus Configuration)

Next, a functional configuration example of the network node 10 and the terminal 20 for performing the processes and operations described above will be described. The network node 10 and the terminal 20 include functions for implementing the embodiments described above. It should be noted, however, that each of the network node 10 and the terminal 20 may include only some of the functions in an embodiment.

<Network Node 10>

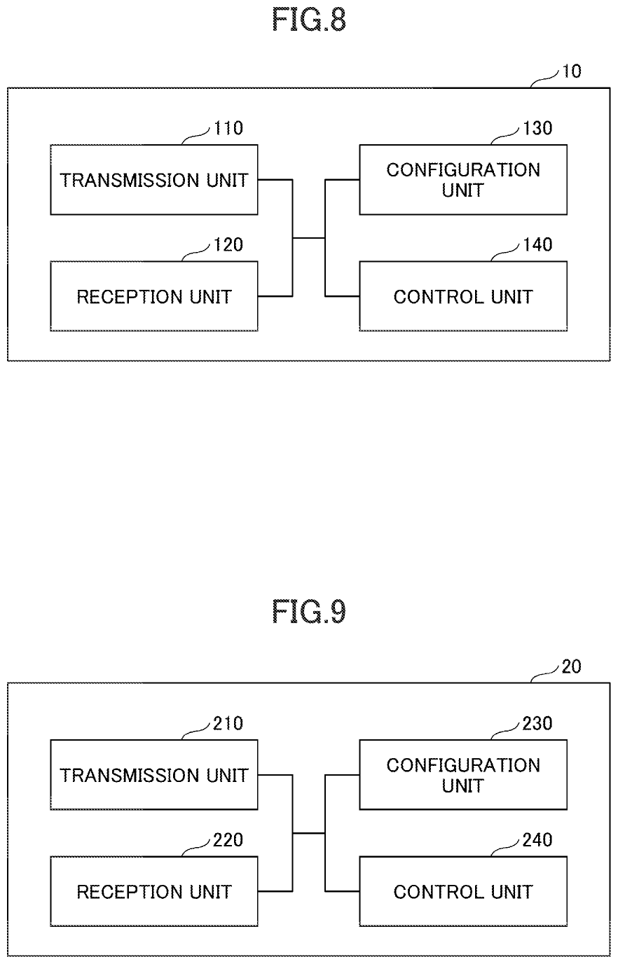

FIG. 8 is a diagram illustrating an example of a functional configuration of the network node 10. As illustrated in FIG. 8, the network node 10 includes a transmission unit 110, a reception unit 120, a configuration unit 130, and a control unit 140. The functional structure illustrated in FIG. 8 is merely an example. Functional divisions and names of functional units may be anything as long as it can perform operations according to an embodiment of the present invention. In addition, the network nodes 10 having multiple different functions in the system architecture may be composed of multiple network nodes 10 separated for each function.

The transmission unit 110 includes a function for generating a signal to be transmitted to the terminal 20 or to the network node 10 and transmitting the signal wirelessly. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, DL reference signals, and the like to the terminal 20.

The configuration unit 130 stores preset configuration information and various configuration information items to be transmitted to the terminal 20 in a storage apparatus and reads the preset configuration information from the storage apparatus if necessary. The content of the configuration information is, for example, information related to QoS parameter management of the PDU session.

As described in the embodiment, the control unit 140 performs processing related to QoS control of the PDU session between the terminal 20 and the user plane. In addition, the control unit 140 may perform processing to implement the function of the application server. The functional units related to signal transmission in the control unit 140 may be included in the transmission unit 110, and the functional units related to signal reception in the control unit 140 may be included in the reception unit 120.

<Terminal 20>

FIG. 9 is a diagram illustrating an example of a functional configuration of the terminal 20. As shown in FIG. 9, the terminal 20 includes a transmission unit 210, a reception unit 220, a configuration unit 230, and a control unit 240. The functional structure illustrated in FIG. 9 is merely an example. Functional divisions and names of functional units may be anything as long as operations according to an embodiment of the present invention can be performed.

The transmission unit 210 generates a transmission signal from transmission data and transmits the transmission signal wirelessly. The reception unit 220 receives various signals wirelessly and obtains upper layer signals from the received physical layer signals. Further, the reception unit 220 has a function for receiving NR-PSS, NR-SSS, NR-PBCH, DL/UL/SL control signals, or reference signals transmitted from the network node 10. Further, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 220 receives, from the another terminal 20, PSCCH, PSSCH, PSDCH, or PSBCH. Furthermore, the transmission unit 210 and the reception unit 220 have a transmission/reception function of a wireless LAN or a wired LAN.

The configuration unit 230 stores various types of configuration information received from the network node 10 or the terminal 20 by the reception unit 220 in the storage device and reads the configuration information from the storage device as necessary. Further, the configuration unit 230 also stores pre-configured configuration information. The content of the configuration information is, for example, information related to QoS parameter management of a PDU session, information related to configuration of D2D communication, and the like.

As described in the embodiment, the control unit 240 performs processing related to QoS control of the PDU session between the terminal 20 and the user plane. Further, the control unit 240 performs control related to D2D communication and QoS control in D2D communication. In addition, the control unit 240 may perform processing for implementing the function of the client application. The functional units related to signal transmission in the control unit 240 may be included in the transmission unit 210, and the functional units related to signal reception in the control unit 240 may be included in the reception unit 220.

(Hardware Structure)

In the above functional structure diagrams used for describing an embodiment of the present invention (FIG. 8 and FIG. 9), functional unit blocks are shown. The functional blocks (function units) may be implemented by a freely-selected combination of hardware and/or software. Further, the means for implementing each functional block is not limited in particular. In other words, each functional block may be implemented by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

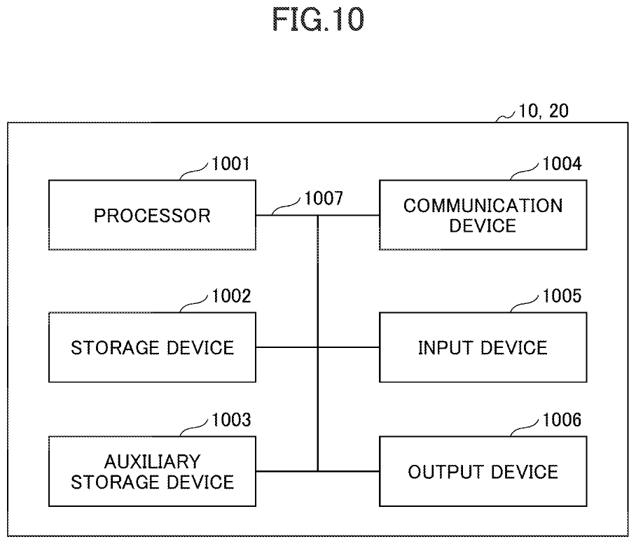

For example, the network node 10, terminal 20, etc., according to an embodiment of the present disclosure may function as a computer for processing the radio communication method of the present disclosure. FIG. 10 is a drawing illustrating an example of hardware structures of the network node 10 and the terminal 20 according to an embodiment of the present invention. Each of the above-described network node 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “apparatus” can be read as a circuit, a device, a unit, etc. The hardware structures of the network node 10 and the terminal 20 may include one or more of each of the devices illustrated in the figure, or may not include some devices.

Each function in the network node 10 and the terminal 20 is implemented by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads a program (program code), a software module, or data from the auxiliary storage apparatus 1003 and/or the communication apparatus 1004, and performs various processes according to the program, the software module, or the data. As the program, a program is used that causes the computer to perform at least a part of operations according to an embodiment of the present invention described above. For example, the control unit 140 of the network node 10 illustrated in FIG. 8 may be realized by control programs that are stored in the storage device 1002 and are executed by the processor 1001. Further, for example, the control unit 240 of the terminal 20 illustrated in FIG. 9 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage apparatus 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage apparatus 1002 may be referred to as a register, a cache, a main memory, etc. The storage apparatus 1002 is capable of storing programs (program codes), software modules, or the like, that are executable for performing communication processes according to an embodiment of the present invention.

The auxiliary storage apparatus 1003 is a computer-readable recording medium, and may include at least one of, for example, an optical disk such as a CD-ROM (Compact Disc ROM), a hard disk drive, a flexible disk, a magneto optical disk (e.g., compact disk, digital versatile disk, Blu-ray (registered trademark) disk), a smart card, a flash memory (e.g., card, stick, key drive), a floppy (registered trademark) disk, a magnetic strip, etc. The above recording medium may be a database including the storage apparatus 1002 and/or the auxiliary storage apparatus 1003, a server, or any other appropriate medium.

The communication apparatus 1004 is hardware (transmission and reception device) for communicating with computers via at least one of a wired network and a wireless network, and may be referred to as a network device, a network controller, a network card, a communication module, etc. The communication apparatus 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input apparatus 1005 is an input device that receives an external input (e.g., keyboard, mouse, microphone, switch, button, sensor). The output apparatus 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage apparatus 1002, etc., are connected to each other via the bus 1007 used for communicating information. The bus 1007 may include a single bus, or may include different buses between the apparatuses.

Further, each of the network node 10 and terminal 20 may include hardware such as a micro processor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

(Embodiment Summary)

As described above, according to an embodiment of the present invention, a terminal is provided. The terminal includes: a reception unit configured to obtain information for starting a service that performs priority control related to communications, the service being applied to a group to which one or more terminals belong; and a control unit configured to start the service for the terminals that belong to the group, by using the information and by a trigger via direct communication between terminals or via a network.

According to the above configuration, the terminal 20 can trigger the start of NaaS from the terminal 20 itself for a plurality of UEs belonging to the NaaS group. In addition, the terminal 20 can cause the base station 10 to trigger the start of NaaS for the multiple UEs belonging to the NaaS group. That is, communication in which QoS (Quality of Service) is provided in direct communication between terminals can be started.

A transmission unit may be further included that is configured to transmit, to terminals belonging to the group, an indication for starting the service request, an indication related to failure, or an indication related to the end of the service. With this configuration, the terminal 20 can trigger the NaaS start and stop the NaaS for multiple UEs belonging to the NaaS group, from the terminal 20 itself.

The transmission unit may transmit the indication including: time for starting or ending the service; and a parameter related to the priority control. According to the above configuration, the terminal 20 can trigger the start of NaaS from the terminal 20 itself for a plurality of UEs belonging to the NaaS group.

A transmission unit may be further included which is configured to transmit, to the base station, an indication for starting the service request. According to the above configuration, the terminal 20 can cause the base station 10 to trigger the start of NaaS for the multiple UEs belonging to the NaaS group.

The indication for starting the service request may include a first condition related to geographic information or a second condition related to the service, the indication for starting the service request may be transmitted from the base station to the terminals that belong to the group in a case where the first condition or the second condition is satisfied. According to the above configuration, the terminal 20 can cause the base station 10 to trigger the NaaS start for multiple UEs belonging to the NaaS group in a case where a specific condition is satisfied, and can cause the base station 10 to end the NaaS in a case where a specific condition is satisfied.

In addition, according to an embodiment of the present invention, a communication method is provided. The communication method includes: obtaining information for starting a service that performs priority control related to communications, the service being applied to a group to which one or more terminals belong; and starting the service for the terminals that belong to the group, by using the information and by a trigger via direct communication between terminals or via a network.

According to the above configuration, the terminal 20 can trigger the start of NaaS from the terminal 20 itself for a plurality of UEs belonging to the NaaS group. In addition, the terminal 20 can cause the base station 10 to trigger the start of NaaS for the multiple UEs belonging to the NaaS group. That is, communication in which QoS (Quality of Service) is provided in direct communication between terminals can be started.

(Supplement of Embodiment)

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, each of the network node 10 and the terminal 20 has been described by using functional block diagrams. However, the apparatuses may be implemented by hardware, software, or a combination of hardware and software. The software executed by a processor included in the network node 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication (transmission, notification) may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC signaling, MAC signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced therefrom. Further, multiple systems may also be applied in combination (e.g., at least one of LTE and LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the network node 10 in the present specification, may be performed by an upper node in some cases. In a network including one or more network nodes including the network node 10, it is apparent that various operations performed for communicating with the terminal 20 may be performed by at least one of the network node 10 and another network node other than the network node 10 (for example, but not limited to, MME or S-GW). According to the above, a case is described in which there is another single network node other than the network node 10. However, the other network node may be a combination of multiple other network nodes (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and wireless technologies (infrared, microwave, etc.), at least one of these wired line technologies and wireless technologies is included within the definition of the transmission medium.

Information, a signal, or the like, described in the present specification may represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “BS: Base Station”, “Radio Base Station”, “Base Station Apparatus”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, or the like. The at least one of the base station and the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station and the mobile station may include an apparatus that does not necessarily move during communication operations. For example, at least one of the base station and the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, a function of the network node 10 described above may be provided by the terminal 20. Further, the phrases “up” and “down” may also be replaced by the phrases corresponding to terminal-to-terminal communication (e.g., “side”). For example, an uplink channel, an downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The “determining” may include, for example, a case in which “judging”, “calculating”, “computing”, “processing”, “deriving”, “investigating”, “looking up, search, inquiry” (e.g., looking up a table, database, or other data structures), or “ascertaining” is deemed as “determining”. Further, the “determining” may include a case in which “receiving” (e.g., receiving information), “transmitting” (e.g., transmitting information), “inputting”, “outputting”, or “accessing” (e.g., accessing data in a memory) is deemed as “determining”. Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “base on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts,” “circuits,” “devices,” etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

An aspect/embodiment described in the present specification may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Note that NaaS is an example of a service involving priority control related to communication.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

The present international patent application is based on and claims priority to Japanese patent application No. 2020-078423 filed on Apr. 27, 2020, the entire contents of which are hereby incorporated herein by reference.

### DESCRIPTION OF THE REFERENCE NUMERALS

10 Network node
110 Transmission unit
120 Reception unit
130 Configuration unit
140 Control unit
20 Terminal
210 Transmission unit
220 Reception unit
230 Configuration unit
240 Control unit
1001 Processor
1002 Storage apparatus
1003 Auxiliary storage apparatus
1004 Communication apparatus
1005 Input apparatus
1006 Output device

What is claimed is:

1. A terminal comprising:
a reception unit configured to obtain information for starting a service that performs priority control related to communications, the service being applied to a group to which one or more terminals belong; and
a control unit configured to start the service for the terminals that belong to the group, by using the information and by a trigger via direct communication between terminals or via a network.

2. The terminal as claimed in claim 1, wherein the terminal further comprising a transmission unit configured to transmit an indication for starting a request for the service to the terminals that belong to the group.

3. The terminal as claimed in claim 2, wherein the transmission unit transmits the indication including: time for starting or ending the service; and a parameter related to the priority control.

4. The terminal as claimed in claim 1, wherein the terminal further comprising a transmission unit configured to transmit, to a base station, an indication for starting a service request, an indication related to a failure, or an indication related to an end of the service.

5. The terminal as claimed in claim 4, wherein
the indication for starting the service request includes a first condition related to geographic information or a second condition related to the service,
the indication for starting the request for the service is transmitted from the base station to the terminals belonging to the group in a case where the first condition or the second condition is satisfied, and
the indication related to the failure indicates that the first condition or the second condition is not satisfied.

6. A communication method performed by a terminal, the communication method comprising:
obtaining information for starting a service that performs priority control related to communications, the service being applied to a group to which one or more terminals belong; and
starting the service for the terminals that belong to the group, by using the information and by a trigger via direct communication between terminals or via a network.
